(19) United States
(12) Patent Application Publication
(10) Pub. No.: US 2013/0000346 A1
(43) Pub. Date: Jan. 3, 2013

(54) DEVICE AND METHOD FOR COOLING SOLID PARTICLES

(76) Inventors: Oleg Golobrodsky, Petach Tekva (IL); Gideon Drori, Sha'arei Tikva (IL)

(21) Appl. No.: 13/560,301

(22) Filed: Jul. 27, 2012

Related U.S. Application Data
(63) Continuation-in-part of application No. 13/054,199, filed on May 6, 2011.

(30) Foreign Application Priority Data
Jul. 14, 2008 (IL) 192797

(51) Int. Cl. F25D 11/02; F25D 17/04

(52) U.S. Cl. 62/404; 62/441

(57) ABSTRACT

A cooling arrangement and system are provided for use in a process of producing brittle particles, and comprising: a first chamber having: a solid particles feed ingress means; a solid particles mixing means; and a solid particles egress means, and a second chamber comprising at least one cooling fluid discharging means, wherein the cooling arrangement is characterized in that there is a low thermal resistance between the first chamber and the second chamber to allow cooling down the solid particles being fed to the first chamber via the solid particles feed ingress means, and wherein the solid particles feed ingress means is operative to introduce solid particles, each having a typical diameter of less than 7 mm.

### CROSS-REFERENCE TO RELATED APPLICATIONS

This application is a continuation-in-part of U.S. patent application Ser. No. 13/054,199 entitled “Device and Method for Cooling Solid Particles” filed Jan. 14, 2011 and being the national phase application of International patent application No. PCT/IL2009/000672 filed on Jul. 6, 2009, which claims priority from Israeli patent application No. 192,797 entitled “Device and Method for Cooling Solid Particles” filed on Jul. 14, 2008, each of which are incorporated herein by reference in its entirety.

### TECHNICAL FIELD

The present invention relates to a method and apparatus for providing air at semi cryogenic temperatures during preparation of various products. In particularly, this invention relates to a method and apparatus for distributing air at semi cryogenic temperatures in cooling chambers during the process of preparing fine powders.

### BACKGROUND OF THE DISCLOSURE

One of the well known environmental challenges nowadays is the handling of used tires. Tire recycling, or rubber recycling, is the process of recycling vehicles' tires that are no longer suitable for use on vehicles due to wear or irreparable damage. These tires are among the largest and most problematic sources of waste, due to the large volume produced and their durability. Those same characteristics, which make waste tires such a problem, also make them one of the most re-used waste materials, as the rubber is very used waste materials, as the is very resilient and can be reused in other products. Approximately, one tire is discarded per person per year. Tires are also often recycled for use on basketball courts and new shoe products. These scrap tires are an ecological predicament in all countries in which automobiles and trucks are a standard mode of transportation. Over the years, many more tires cast off in monumental piles than recycled or burned. It is estimated that in the US alone there are in excess of 1 billion tires in illegal tire piles, generating dangerous conditions of uncontrollable fires, air pollution as well as health hazards.

To date, most discarded tires were destined to be burned, assisting in alleviating an unending energy crisis. However, since the recognition by meteorologists of pending earth warming trends, burning tires is quickly becoming unacceptable solution and in some countries even illegal. Also, to date, many of the waste tires are simply shredded and buried in landfills. This too has become an undesirable solution as more and more countries recognize the danger in underground buried tires or tire parts, due to the adverse effect on the diminishing underground supplies of fresh water. Finally, tire piles serve as breeding grounds to colonies of disease infected rodents and incubation hot beds for dangerous and deadly insects. It is therefore clear that recycling must be the only acceptable and sustainable solution to the increasing problem of scrap tires.

Recognizing all of the above, several attempts have been made to reduce the increasing number of scrap tires discarded annually by recycling them. Tire recycling has traditionally been accomplished using three distinctly different technologies:

All mechanical ambient grinding the rubber;

Cryogenically, freezing and crushing the rubber; and

Pyrolysis or microwave treatment to melt rubber.

There are quite few aspects involved in implementing the second type of technology, namely, the cryogenically, freezing and crushing the rubber to produce granular rubber, which may be used as a supplementary material in fuel or in road building, etc. One of the aspects involved in this technology is the step of exposing the crushed rubber to reduced temperatures e.g. to a point of embrittling the synthetic rubber.

Many conventional cryogenic recycling processes require the use of liquid nitrogen or solid carbon dioxide to lower the temperature of the material to be recycled to a point where a proceeding step of the process can yield a granular material such as a powder. However, such cryogenic processes are usually expensive to implement and to operate.

Many solutions were proposed in the past to improve this cooling step of the process. Few of these solutions are the following:

U.S. Pat. No. 4,273,294 discloses an improvement of conventional cryogenic grinding system incorporating an impact mill by providing means to allow at least 70% of the embrittled material entering the mill to bypass the mill's inlet and means to restrict the flow of the cold gas through the impact mill.

U.S. Pat. No. 5,408,846 describes a cooling device for lowering the temperature of rubber or polystyrene materials for recycling purposes. The cooling device has an input feeder which inputs the material to be treated into a cooling chamber. The cooling chamber is an elongated chamber. The cooling chamber receives cold air from an external air refrigeration unit and circulates that air within the chamber. The material input into the cooling chamber is circulated therein by a circulating shaft. After 15-20 minutes, the input material is discharged through an output on the opposite end of the cooling chamber. The material discharged temperature is −80° C. or lower.

U.S. Pat. No. 5,568,731 discloses an ambient air freezing system for producing chilled air in the cryogenic range of −120° C. to −180° C. without the use of cryogenic chemicals or other refrigerants.

U.S. Pat. No. 6,360,547 describes a method for cryogenically freezing materials, such as rubber, food, plastics by compressing ambient air to a first level, cooling the air back to an ambient temperature, compressing the air again, and then cooling the air followed by expanding the compressed air thereby cooling it down to cryogenic temperatures that is fed to the material to be processed.

U.S. Pat. No. 6,397,623 describes a cooling device in which the compressor and the expander are coupled to one crank shaft or interlocked crank shafts so as to use the expansion energy from the compressed air in the expander as an energy for compressing the outside air in the compressor, thereby reducing the running cost.

U.S. Pat. No. 7,125,439 discloses a method for providing clean air to an environment, by cooling incoming air, which may be contaminated with chemical, nuclear or biological contamination and removing water from the cooled air. The cooled air is passed through a regenerative pressure swing absorption system which removes the contaminants. The resulting, cleaned, air is expanded by an expander and is provided to the environment.

Our co-pending patent application published under US 2011-0204165 discloses a cooling arrangement for use in a process of preparing a fine powder, which comprises a plurality of cooling air discharging devices which allow the cooling air to be in direct contact with the grinded material (e.g. grinded tires) and a solid particles mechanical mixing means, which is adapted to ensure that no big lumps of particles are formed within said cooling arrangement.

### SUMMARY OF THE DISCLOSURE

It is an object of the present invention to provide a method and apparatus for efficiently lowering the temperature of used tires, rubber and the like, to cryogenic levels.

It is another object of the present invention to provide a method and apparatus to eliminate the need for separation of the cooling fluid (e.g. air) from particles of the material being cooled that are carried together with the cooling fluid.

It is still another object of the present invention to provide a method and apparatus for rapid lowering the temperature of used tires, rubber and the like, to cryogenic levels thereby reducing the period required for the material being cooled to remain within the cooling chamber.

Other objects of the present invention will become apparent from the following description.

According to a first embodiment of the invention, there is provided a cooling arrangement adapted for use in a process of producing brittle particles, and comprising:

a first chamber having:
a solid particles feed ingress means;
a solid particles mixing means; and
a solid particles egress means, and
a second chamber comprising at least one cooling fluid discharging means,
wherein the cooling arrangement is characterized in that there is a low thermal resistance between the first chamber and the second chamber to allow cooling down the solid particles being fed to the first chamber via the solid particles feed ingress means, and
wherein the solid particles feed ingress means is operative to introduce solid particles, each having a typical diameter of less than 7 mm.

According to another embodiment, the first chamber and the second chamber share a common wall. Preferably, the first chamber is substantially surrounded by the second chamber.

By yet another embodiment, the first chamber is essentially of a conical shape. Preferably, the first chamber having essentially a conical shape is completely surrounded by the second chamber. As will be appreciated by those skilled in the art, this embodiment is not restricted to any particular shape of the second chamber.

In accordance with another embodiment, the second chamber comprises a plurality of cooling air discharging means.

By still another embodiment, each of the at least one cooling fluid discharging means is adapted to receive the cooling fluid from an expanding device.

In accordance with another embodiment, the solid particles feed ingress means is located essentially at the top section of the first chamber whereas the solid particles egress means is located essentially at the bottom section of that first chamber.

By still another embodiment, the cooling arrangement is further adapted to allow the solid particles fed via the solid particles feed ingress means, to free fall onto the bottom section of the cooling arrangement, where they are mixed by a mechanical mixing means for a pre-defined period of time, and thereafter to enable their conveyance towards the next step of the powder preparation process.

In accordance with yet another embodiment, the temperature to which the solid particles are indirectly cooled (i.e. in non-direct contact) by the cooling fluid, is in the range of −70° C. to −110° C.

According to another aspect there is provided a system for use in a process of recovering material contained in used tires, wherein the system comprises: one or more compressing devices adapted to compress a cooling fluid to a pressure in the range of 10 to 15 bar;

one or more expanders operative to receive the pressurized cooling fluid and expand it so that its temperature is lowered to a level required for operating a cooling arrangement;

a cooling arrangement which comprises:
a first chamber having:
   a solid particles feed ingress means;
   a solid particles mixing means; and
   a solid particles egress means, and
a second chamber comprising at least one cooling fluid discharging means,

wherein the cooling arrangement is characterized in that there is a low thermal resistance between the first chamber and the second chamber to allow cooling down the solid particles being fed to the first chamber via the solid particles feed ingress means, by the expanded cooling fluid, and

wherein the solid particles feed ingress means is operative to introduce solid particles, each having a typical diameter of less than 7 mm.

According to another embodiment, the first chamber is substantially surrounded by the second chamber.

By yet another embodiment, the first chamber has essentially a conical shape, and is completely surrounded by the second chamber.

According to still another embodiment, the system further comprises recycling means operative to enable return of the cooling fluid leaving the chamber to the one or more compressing devices.

In accordance with another embodiment, the cooling fluid is air and the second chamber comprises a plurality of cooling air discharging means.

### BRIEF DESCRIPTION OF THE DRAWINGS

FIG. 1 illustrates a schematic diagram of the cooling arrangement according to the present invention for air cooling particles in a batch operation to cryogenic temperatures; and

FIG. 2 illustrates a schematic diagram of a system according to another aspect of the present invention for air cooling solid particles.

### DETAILED DESCRIPTION OF PREFERRED EMBODIMENTS

A better understanding of the present invention is obtained when the following non-limiting detailed examples are considered in conjunction with the accompanying drawings.

As previously discussed, one of the objects of the present invention is to provide method and means to cool down solid particles such as recycled tires particles so that the end product of the whole recycling process, of which the cooling process described and claimed herein is a part, are particles that are in a form of fine or even ultrafine powder, typically particles of 1μ or less, and at the same time ensure the ability to re-use the cooling fluid without having to filter out the particles from the cooling fluid on one hand, while achieving a certain energy saving on the other. Although various processes were suggested in the past to produce fine powders, still, they are rather expensive to operate as they either make use of refrigerants or cryogenic chemicals, or characterized by being an inefficient ambient grinding processes. Due to high production cost and other inefficiencies, ultra fine products have not been produced in large quantities from recycled materials. The solution provided by the present invention aims to overcome these obstacles.

Although the invention is described hereinafter in connection with a process of recycling synthetic rubber such as rubber that originates from used tires, still, this is done for the convenience of the reader and the scope of the invention should not be understood to be restricted to that specific process.

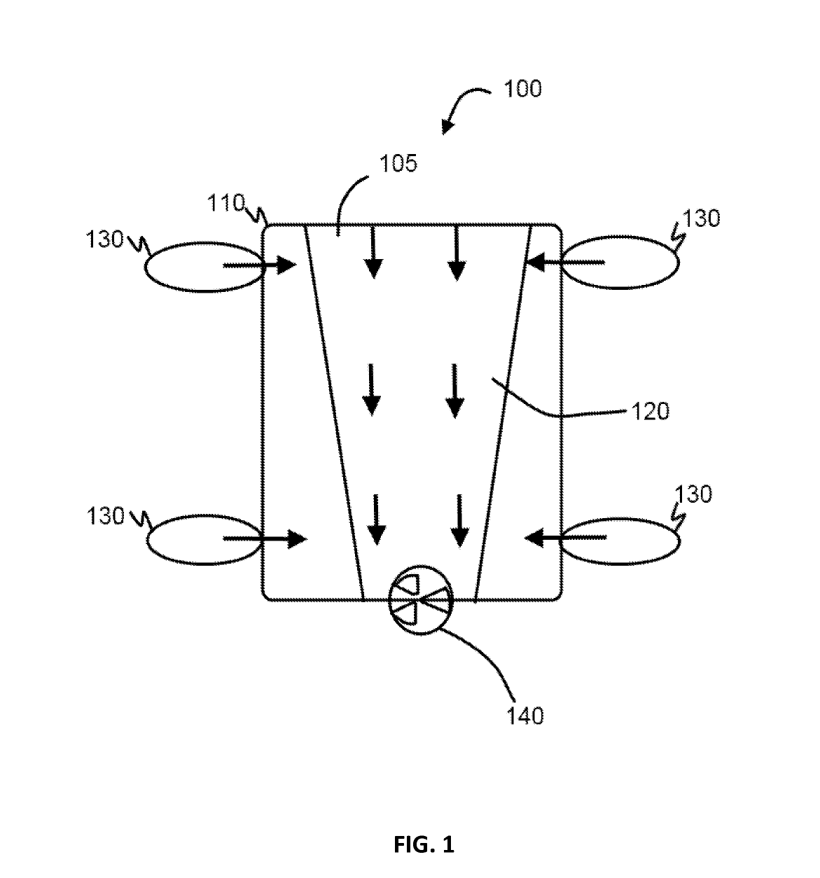

Turning now to the drawings, FIG. 1 illustrates a cooling arrangement 100 that comprises chamber 105 to which a pre-defined quantity (e.g. by weight) of synthetic rubber particles derived from processing used tires is conveyed by using any applicable solids conveying means known in the art per se such as conveying belt (not shown in this Fig.), and chamber 110 to which the cooling fluid is introduced. Typically, the particles which are of an averaged diameter in the range of 1 to 5 mm are fed into the top section of chamber 105, and allowed to free fall 120 (or alternatively to force fall, e.g. while undergoing a swirling motion) towards the bottom of chamber 105, where they are subjected to mixing operation of mixer/stirrer 140. During their fall, there is an initial cooling of the particles. The mixer/stirrer (e.g. a rotary device) operates to ensure that no big lumps of particles are formed and that all the particles will be subjected to the cooling air, in order to obtain a substantially homogenous temperature at the range of −80° C. to −100° C. of the synthetic rubber particles present in the chamber. At the same time, a plurality of cooling air discharging devices 130 are operative to circulate cooling air through chamber 110 in order to cool the walls of this chamber 108 and thereby to cool down chamber 105 and its content, i.e. the particles that are introduced thereto. Four such cooling air discharging devices are illustrated in FIG. 1, demonstrating the introduction of cooling air from each side of the second chamber 110. The air reaching each of these cooling air discharging devices is preferably cleaned, dried and compressed prior to reaching the air discharging devices, although in the alternative all these operations can be carried out within the cooling air discharging devices themselves and hence this alternative should also be considered to be encompassed by the present invention. In the present example, the cooling air is introduced to the chamber at −90° C. or lower and at a pressure of few atmospheres. When introduced into the chamber, the air expands, thereby causing its own temperature to drop further. Typically, the particles stay in chamber 104 for about 10 to 15 minutes. Thereafter, the particles are discharged at the chamber's bottom section airlock after they have become brittle and consequently easy to pulverize, to another solid conveying means for further processing the frozen granules, e.g. they can then be further ground or crushed to produce the desired ultra fine powder.

Although the present invention was described in the above example in connection with synthetic rubber particles obtained from used tires, as will be understood by those skilled in the art it can be used for cryogenically cooling materials such as polymers, rubber based materials and the like without using refrigerants or cryogenic chemicals in the process.

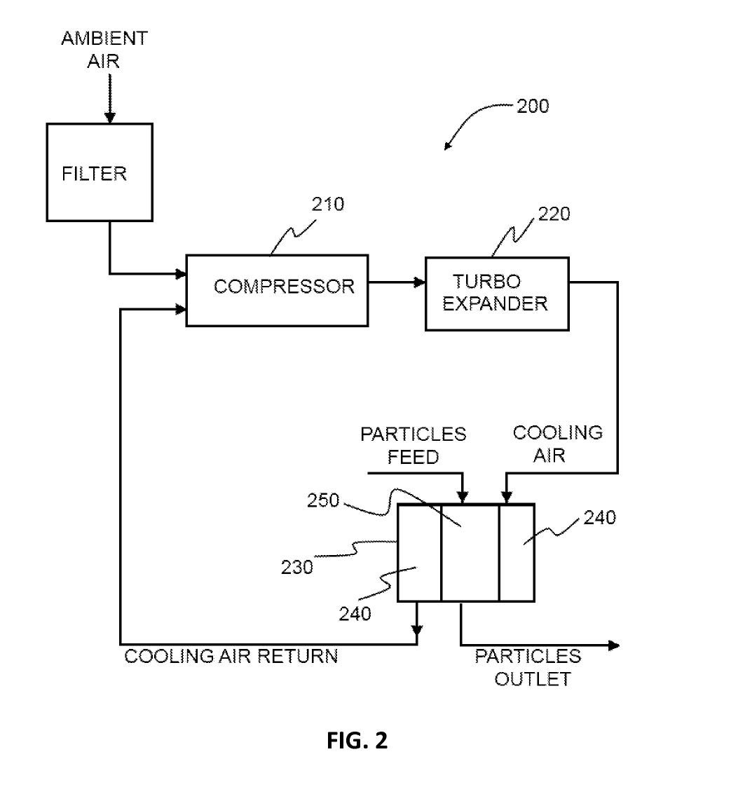

FIG. 2 illustrates a schematic diagram of a system 200 according to another aspect of the present invention for air cooling solid particles.

In order to obtain the cooling air required for the process any method known in the art per se, that is applicable to produce the air at the right physical conditions of temperature and pressure and the right cleanness and dryness levels can be used. For example, by ambient air is drawn and compressed by compressor 210. It is then expanded by using multiple turbo expander machines 220. The oil resulting from the compression is removed and the air is cleaned and dried before compression. The cooled air leaving the turbo expander machines 220 at a temperature in the range of from about −80 to about −100° C. is fed into chamber 240 of cooling arrangement 230.

A suitable filter for the air preparation process could be an inertial separator. This may be achieved by passing the air through a filter, such as a Borosilicate micro-fiber filter, in which water, oil and particles are removed using a coalescing effect. Alternatively a silica gel or an activated alumina could be used as an adsorbent, so as to dry the air by chemically reacting to the water vapor in the air within the filter to adsorb and remove the water vapor.

Another option is using a thermodynamic cycle, otherwise known as the “Russian cycle”, where the compressor and turbo expander are located in one cylinder and chamber connected horizontally with the motor so as to use the expansion energy from the compressed air in the expander as an energy for compressing the outside air in the compressor, thereby reducing the running cost. The unit is environmentally friendly low-temperature cycle (up to −110° C.) enclosed in one functional block aggregate, and can be fully automated.

The air passing through chamber 240 cools down chamber 240, thereby causing the cooling down of chamber 250 and the particles contained therein. After passing through chamber 240, the cooling air is returned to compressors 210 where it will be compressed again. This way, only a small amount of ambient air will have to be drawn by compressors 210, and for the air leaving the compressors at about 10 to 15 bars, less energy will have to be invested every time such a cycle occurs.

As will be appreciated by those skilled in the art, although the particles themselves undergo a batch type of operation as they are maintained within the chamber for a predefined period of time, still, the recycling of the cooling air is a continuous type of operation, independent of the process which the particles are subjected to.

While only the above embodiments of the present invention have been illustrated and described, it is to be understood that many changes and modifications may be made thereto without departing from the spirit and scope of the invention as defined in the appended claims.

The present invention has been described using non-limiting detailed descriptions of preferred embodiments thereof that are provided by way of example and are not intended to limit the scope of the invention. It should be understood that features described with respect to one embodiment may be used with other embodiments. Variations of embodiments described will occur to persons of the art. Furthermore, the terms “comprise”, “include”, “have” and their conjugates shall mean, when used in the claims “including but not necessarily limited to”. Also when term was used in the singular form it should be understood to encompass its plural form and vice versa, as the case may be.

1. A cooling arrangement adapted for use in a process of producing brittle particles, and comprising:
a first chamber having:
a solid particles feed ingress means;
a solid particles mixing means; and
a solid particles egress means, and
a second chamber comprising at least one cooling fluid discharging means,
wherein the cooling arrangement is characterized in that there is a low thermal resistance between the first chamber and the second chamber to allow cooling down the solid particles being fed to the first chamber via the solid particles feed ingress means, and
wherein the solid particles feed ingress means is operative to introduce solid particles, each having a typical diameter of less than 7 mm.

2. The cooling arrangement of claim 1, wherein said first chamber and said second chamber share a common wall.

3. The cooling arrangement of claim 1, wherein said first chamber is essentially of a conical shape.

4. The cooling arrangement of claim 1, wherein said second chamber comprises a plurality of cooling air discharging means.

5. The cooling arrangement of claim 1, wherein each of the at least one cooling fluid discharging means is adapted to receive said cooling fluid from an expanding device.

6. The cooling arrangement of claim 1, wherein said solid particles are indirectly cooled by said cooling fluid to a temperature that is in the range of from about −70° C. to about −110° C.

7. A system for use in a process of recovering material contained in used tires, wherein the system comprises:
one or more compressing devices adapted to compress a cooling fluid;
one or more expanders operative to receive the pressurized cooling fluid and expand it so that its temperature is lowered to a level required for operating a cooling arrangement of said system;
a cooling arrangement which comprises:
a first chamber having:
a solid particles feed ingress means;
a solid particles mixing means; and
a solid particles egress means, and
a second chamber comprising at least one cooling fluid discharging means,
wherein the cooling arrangement is characterized in that there is a low thermal resistance between the first chamber and the second chamber to allow cooling down the solid particles being fed to the first chamber via the solid particles feed ingress means, by the expanded cooling fluid, and
wherein the solid particles feed ingress means is operative to introduce solid particles, each having a typical diameter of less than 7 mm.

8. The system according to claim 7, wherein said first chamber is substantially surrounded by said second chamber.

9. The system according to claim 7, wherein said first chamber has essentially a conical shape, and is completely surrounded by the second chamber.

10. The system according to claim 7, wherein said first system further comprises recycling means operative to enable return of the cooling fluid leaving the chamber to the one or more compressing devices.

11. The system according to claim 7, wherein said cooling fluid is air and the second chamber comprises a plurality of cooling air discharging means.
